(19) United States
(12) Patent Application Publication
(10) Pub. No.: US 2016/0274890 A1
(43) Pub. Date: Sep. 22, 2016

(54) MULTI-PLATFORM DEVICE TESTING

(71) Applicant: Zynga Inc., San Francisco, CA (US)

(72) Inventors: Daniel Ian Sternfeld, San Francisco, CA (US); Katherine Lee, San Francisco, CA (US); Sora Bai, San Francisco, CA (US); David Baack, Daly City, CA (US); William Wai Nang Yip, Toronto (CA); Rajesh Patel, Maple (CA)

(21) Appl. No.: 14/854,617

(22) Filed: Sep. 15, 2015

Related U.S. Application Data
(63) Continuation-in-part of application No. 14/662,704, filed on Mar. 19, 2015.

(51) Int. Cl. G06F 9/445; G06F 9/44

(52) U.S. Cl. CPC G06F 8/65; G06F 8/34

(57) ABSTRACT

Techniques for modifying a game application on different client devices are described herein. A tool chain module can receive, from a development tool, a modification code defining a game modification of a game application. The game application can be installed on a first client device and a second client device. Additionally, the tool chain module can generate a modification file based on the modification code. The modification file can define the game modification in a platform-independent format. The modification file can be transmitted to the first client device having a first operating system. Moreover, the modification file can be transmitted to the second client device having a second operating system. The second operating system can be different from the first operating system. Furthermore, the tool chain module can cause an update of the game application, on the first client device and the second client device, using the modification file.

### CROSS-REFERENCE TO RELATED APPLICATION

This application is a continuation-in-part to U.S. patent application Ser. No. 14/662,704 titled “Modifying Client Device Game Applications,” filed Mar. 19, 2015, which is incorporated herein by reference in its entirety.

### TECHNICAL FIELD

The present disclosure generally relates to multi-platform device testing and, in particular embodiments, to techniques for performing seamless software updates on different computer hardware platforms and operating systems.

### BACKGROUND

In many game applications, a game developer may need to use several development tools to modify an online game application. For example, a portion of the modification may need to be implemented with one development tool (e.g., graphic editor) while another portion of the modification may need another development tool (e.g., animation systems).

Additionally, on the client side, once the game application is updated by the game developer, the game user often has to manually update the game application in order to use the current version of the game application. For example, updating a game application using a mobile device can include downloading a newer version from an application store and installing the newer version on the mobile device.

Furthermore, with current implementations, collaboration between game developers tends to be cumbersome and time-consuming. For example, a game developer sometimes has to go through the process of using a number of different development tools to update the game application to make a single modification. Therefore, game developers tend to update the live game application only after enough changes have been made in order to justify the time and effort associated with updating the game application. Such update delays can exacerbate collaboration issues, such as avoiding parallel modifications by different game developers, which can be problematic when multiple game developers are simultaneously working on modifications to a common game application.

### BRIEF DESCRIPTION OF THE DRAWINGS

FIG. 1 is a schematic diagram showing an example of a system, according to some example embodiments.

FIG. 2 is a block diagram illustrating components of a tool chain module, according to some example embodiments.

FIG. 3 illustrates an exemplary block diagram of components for designing a game level using current implementations.

FIG. 4 illustrates a block diagram of components for designing a game level using the tool chain module 201, according to some embodiments.

FIG. 5 is a flowchart showing an example technique for seamlessly updating a game application, according to some example embodiments.

FIG. 6 is a flowchart showing an example method of generating and transmitting a modification file to two different client devices for updating a game application, according to some embodiments.

FIG. 7 is a diagrammatic representation of an example data flow between example components of the system of FIG. 1, according to some example embodiments.

FIG. 8 illustrates an example computing system architecture, according to some example embodiments.

### DETAILED DESCRIPTION

A system, a machine-readable storage medium storing instructions, and a computer-implemented method are described herein to seamlessly implement modifications within a game application on different devices. In the following description, for purposes of explanation, numerous specific details are set forth in order to provide a thorough understanding of example embodiments. It will be evident, however, to one skilled in the art, that the present technology may be practiced without these specific details.

According to various embodiments, a tool chain module can assist a game developer to seamlessly modify items in a game application. Modifiable items in a game application can include, but are not limited to, a game level, an in-game art object, an in-game animation, and an in-game virtual object. Examples of game modifications can include level generation and modification, art asset generation and modification (e.g., pixel pushing), and animation generation and modification.

In many current implementations, each modification involves interaction with separate development tools (e.g., graphic editor, animation software, etc.). As a result, the game developer implements a portion of the modification with one development tool while another portion of the modification is implemented with another development tool. Given that each development tool generates an output format unique to that development tool, an output format from a first development tool may have to be converted into a standard format before being inputted into a second development tool. Additionally, after the modification is completed using the various development tools, the output from the last development tool may then have to be converted to binary code. Moreover, the binary code can then be converted to distribution code that is specific to various operating systems of the receiving client devices. The distribution code is generated based on particular distribution protocols for various mobile devices.

As a result of the utilization of the different development tools, the conversion of the different development tool output formats, the conversion to the binary code, and the conversion to the distribution code, substantial overhead and redundancy is created for updating a game application, especially when only a minor game modification is being made, such as rendering or changing one virtual object (e.g., art asset). Therefore, with current implementations, the amount of time to implement a modification can take about an hour to a day, depending on the complexity of the modification.

In contrast, by use of the tool chain module, the modification can be implemented almost instantaneously on a plurality of client devices having different platforms (e.g., operating system, user interface layout). For example, when an animation needs to be further modified based on testing, the animator can simply update the animation within an extension of the tool chain module and push the updated animation to the game application within seconds. By allowing an extension of the tool chain module to push out content in a format useable by the game application (e.g., text representation of attributes associated with the game modification), the tool chain module can bypass intermediary steps that would otherwise have been performed.

According to various embodiments, the tool chain module can reduce the time and effort for modifying a game application. For example, when a game modification is made, the tool chain module can receive modification information (e.g., modification code, modification file) from a plurality of development tools. The modification information can be different formats associated with each development tool. The tool chain module is able to recognize and interpret the output format of each development tool, and merge the plurality of received outputs from the development tools into a composite modification file that can represent the game modification in its entirety.

In some instances, the tool chain module can present a user interface that incorporates the plurality of development tools. The tool chain module can include a software extension that allows a game developer to modify any aspect of the game application. Therefore, the game developer can utilize the different development tools within a single user interface to generate the game modification in its entirety. In contrast, with current implementations, the game developer may have to switch between different development tools, each development tool having its own user interface, in order to generate the game modification. By presenting a single user interface, the tool chain module can facilitate a game developer's easily making edits directly into the game application.

The output of the tool chain module can be a composite modification file (e.g., single modification file). The composite modification file can include attributes associated with the game modifications. Each attribute can be a data object that is stored or embodied in the modification file. The data object may take many forms, including text (e.g., ASCII, SGML, and HTML), images, graphics (vector-based or bitmap), audio, video, other multimedia, and combinations thereof. The data object may also include executable code objects (e.g., games executable within a browser window or frame).

After the composite modification file has been generated, the composite modification file can be pushed (e.g., uploaded) onto a game networking system. For example, the composite modification file can include text representations of attributes associated with the game modification. Additionally, the composite modification file can be automatically encapsulated with binary code or distribution code in order for the game application on the client device to automatically receive the modification information. The encapsulation allows for a seamless transmission of the composite modification file without a game developer requesting a conversion of the file.

Moreover, the composite modification file can be used by the game developers to almost instantly view or test the game modification on a plurality of client devices having different platforms. By almost instantly viewing or testing the game modification on a plurality of devices, the game developer can save time during the testing phase of the game modification. Previously, the game developer had to generate a plurality of game modification files for each client device based on the platform of the client device. For example, a game modification file may have been generated with a different distribution code based on the operating system of the client device. Accordingly, without the tool chain module, game developers had to generate a plurality of game modification files for the same game modification, which was time-consuming and cumbersome.

Furthermore, the game modification file can be transmitted to the client device. In some instances, a client device may already have the game application installed. The game application can include software to decapsulate the information received from the tool chain module. Decapsulation can include removing the binary code or distribution code to obtain the text representations of attributes associated with the game modification. Once the information received is decapsulated, the client device can read the composite modification file and process the modifications to update the game application. Additionally, the game networking system can push the modification to the client device and update the game without requiring the client device to re-install a new version of the whole game.

According to various embodiments, the tool chain module can generate a modification file (e.g., composite modification file) based on a received development tool output format from a first user and another received development tool output format from a second user. By receiving inputs from a plurality of users, the tool chain module can allow different users to work on different portions of a game modification independently.

It is to be understood that various embodiments include the generation of one or more modules that comprise source code that, when compiled by a computing device(s), creates object code that causes the computing device(s) to perform one or more operations described herein. In other embodiments, any of the modules comprise object code that causes the computing device(s) to perform various operations described herein.

Other embodiments include the generation of one or more modules that comprise source code that, when compiled by a client computing device(s), creates object code that causes the client computing device(s) to perform one or more operations described herein in communication with a server computing device(s). In other embodiments, any of the modules comprise object code that causes the client computing device(s) to perform various operations described herein in communication with the server computing device(s).

Other embodiments include the generation of one or more modules that comprise source code that, when compiled by a server computing device(s), creates object code that causes the server computing device(s) to perform one or more operations described herein in communication with one or more client computing devices. In other embodiments, any of the modules comprise object code that causes the server computing device(s) to perform various operations described herein in communication with the one or more client computing devices.

### Social Networking Systems and Game Networking Systems

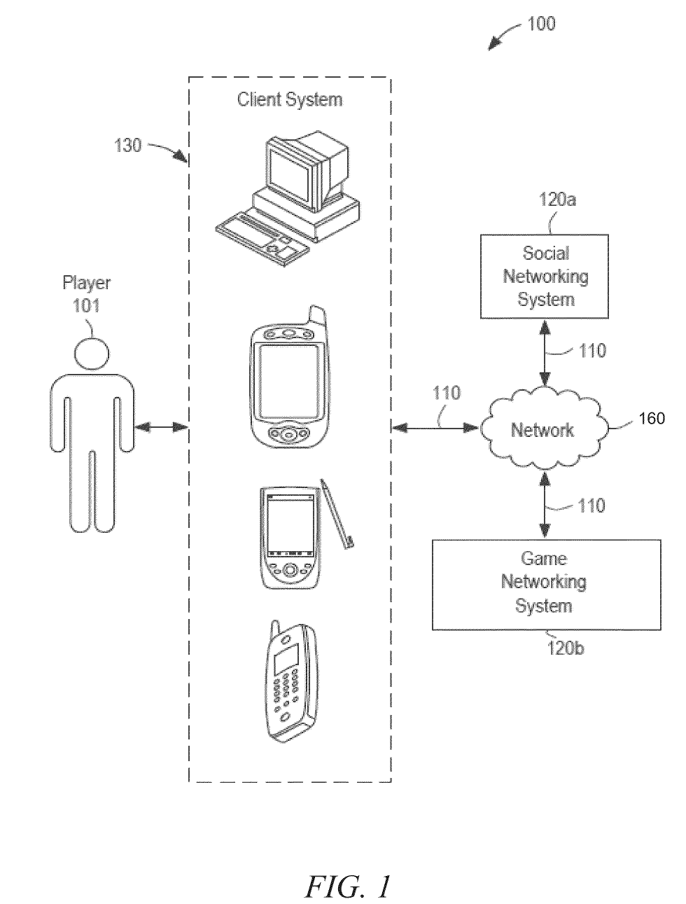

FIG. 1 illustrates an example of a system 100 for implementing various disclosed embodiments. In particular embodiments, the system 100 comprises a player 101, a social networking system 120a, a game networking system 120b (i.e., online gaming system), a client system 130, and a network 160. The components of the system 100 can be connected to each other in any suitable configuration, using any suitable type of connection. The components may be connected directly or via the network 160, which may be any suitable network. For example, one or more portions of the network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, another type of network, or a combination of two or more such networks.

The social networking system 120a is a network-addressable computing system that can host one or more social graphs. The social networking system 120a can generate, store, receive, and transmit social networking data. The social networking system 120a can be accessed by the other components of the system 100 either directly or via the network 160. The game networking system 120b is a network-addressable computing system that can host one or more online games. The game networking system 120b can generate, store, receive, and transmit game-related data, such as, for example, game account data, game input, game state data, and game displays. The game networking system 120b can be accessed by the other components of the system 100 either directly or via the network 160. The player 101 may use the client system 130 to access, send data to, and receive data from the social networking system 120a and the game networking system 120b. The client system 130 can access the social networking system 120a or the game networking system 120b directly, via the network 160, or via a third-party system. As an example, and not by way of limitation, the client system 130 may access the game networking system 120b via the social networking system 120a. The client system 130 can be any suitable computing device, such as a personal computer, laptop, cellular phone, smartphone, computing tablet, etc.

Although FIG. 1 illustrates a particular number of players 101, social networking systems 120a, game networking systems 120b, client systems 130, and networks 160, this disclosure contemplates any suitable number of players 101, social networking systems 120a, game networking systems 120b, client systems 130, and networks 160. As an example and not by way of limitation, the system 100 may include one or more game networking systems 120b and no social networking systems 120a. As another example and not by way of limitation, the system 100 may include a system that comprises both the social networking system 120a and the game networking system 120b. Moreover, although FIG. 1 illustrates a particular arrangement of the player 101, the social networking system 120a, the game networking system 120b, the client system 130, and the network 160, this disclosure contemplates any suitable arrangement of the player 101, the social networking system 120a, the game networking system 120b, the client system 130, and the network 160.

The components of the system 100 may be connected to each other using any suitable connections 110. For example, suitable connections 110 include wireline (such as, for example, digital subscriber line (DSL) or Data Over Cable Service Interface Specification (DOCSIS)), wireless (such as, for example, Wi-Fi or Worldwide Interoperability for Microwave Access (WiMAX)), or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, another type of connection, or a combination of two or more such connections. The connections 110 need not necessarily be the same throughout the system 100. One or more first connections 110 may differ in one or more respects from one or more second connections 110. Although FIG. 1 illustrates particular connections 110 among the player 101, the social networking system 120a, the game networking system 120b, the client system 130, and the network 160, this disclosure contemplates any suitable connections 110 among the player 101, the social networking system 120a, the game networking system 120b, the client system 130, and the network 160. As an example, and not by way of limitation, in particular embodiments, the client system 130 may have a direct connection to the social networking system 120a or the game networking system 120b, bypassing the network 160.

### Online Games and Game Systems

Game Networking Systems

In an online computer game, a game engine manages the game state of the game. The game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs) and in-game objects. The game engine also manages the game state, including player character states for currently active (online) and inactive (offline) players 101.

An online game can be hosted by the game networking system 120b (i.e., online gaming system), which includes a notification generator that performs operations according to embodiments as described herein. The game networking system 120b can be accessed using any suitable connection 110 with a suitable client system 130. A player 101 may have a game account on the game networking system 120b, wherein the game account can contain a variety of information associated with the player 101 (e.g., the player 101's personal information, financial information, purchase history, player character state, game state). In some embodiments, a player 101 may play multiple games on the game networking system 120b, which may maintain a single game account for the player 101 with respect to all the games, or multiple individual game accounts for the player 101 with respect to each game. In some embodiments, the game networking system 120b can assign a unique identifier to each player 101 of an online game hosted on the game networking system 120b. The game networking system 120b can determine that a player 101 is accessing the online game by reading the player 101's cookies, which may be appended to HTTP requests transmitted by the client system 130, and/or by the player 101 logging onto the online game.

In particular embodiments, the player 101 may access an online game and control the game's progress via the client system 130 (e.g., by inputting commands to the game at the client system 130). The client system 130 can display the game interface, receive inputs from the player 101, transmit user inputs or other events to the game engine, and receive instructions from the game engine. The game engine can be executed on any suitable system (such as, for example, the client system 130, the social networking system 120a, or the game networking system 120b). As an example, and not by way of limitation, the client system 130 can download client components of an online game, which are executed locally, while a remote game networking system, such as the game networking system 120b, provides backend support for the client components and may be responsible for maintaining application data of the game, processing the inputs from the player 101, updating and/or synchronizing the game state based on the game logic and each input from the player 101, and transmitting instructions to the client system 130. As another example, and not by way of limitation, each time the player 101 provides an input to the game through the client system 130 (such as, for example, by typing on the keyboard or clicking the mouse of the client system 130), the client components of the game may transmit the player 101's input to the game networking system 120b.

### Storing Game-Related Data

A database may store any data relating to game play within a game networking system 120b. The database may include database tables for storing a player game state that may include information about the player 101's virtual gameboard, the player 101's character, or other game-related information. For example, the player game state may include virtual objects owned or used by the player 101, placement positions for virtual structural objects in the player 101's virtual gameboard, and the like. The player game state may also include in-game obstacles or tasks for the player 101 (e.g., new obstacles, current obstacles, completed obstacles, etc.), the player 101's character attributes (e.g., character health, character energy, amount of coins, amount of cash or virtual currency, etc.), and the like.

The database may also include database tables for storing a player profile that may include user-provided player information that is gathered from the player 101, the player 101's client device, or an affiliate social network. The user-provided player information may include the player 101's demographic information, the player 101's location information (e.g., a historical record of the player 101's location during game play as determined via a GPS-enabled device or the Internet Protocol (IP) address for the player 101's client device), the player 101's localization information (e.g., a list of languages chosen by the player 101), the types of games played by the player 101, and the like.

### Game Systems, Social Networks, and Social Graphs:

In an online multiplayer game, players 101 may control player characters (PCs), a game engine controls non-player characters (NPCs) and game features, and the game engine also manages player character states and a game state and tracks the states for currently active (i.e., online) players 101 and currently inactive (i.e., offline) players 101. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), etc. The game engine may use player character states to determine the outcomes of game events, sometimes also considering set or random variables. Generally, a player character's probability of having a more favorable outcome is greater when the player character has a better state. For example, a healthier player character is less likely to die in a particular encounter relative to a less healthy player character or non-player character. In some embodiments, the game engine can assign a unique client identifier to each player 101.

In particular embodiments, a player 101 may access particular game instances of an online game. A game instance is a copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible only by specific players 101) or non-exclusive (i.e., accessible by any player 101). In particular embodiments, a game instance is populated by one or more player characters controlled by one or more players 101 and one or more in-game objects controlled by the game engine. When accessing an online game, the game engine may allow a player 101 to select a particular game instance to play from a plurality of game instances. Alternatively, the game engine may automatically select the game instance that the player 101 will access. In particular embodiments, an online game comprises only one game instance that all players 101 of the online game can access.

In particular embodiments, a game engine can interface with a social graph. Social graphs are models of connections between entities (e.g., individuals, users, contacts, friends, players 101, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player 101 or player character in an online multiplayer game, though this disclosure may apply to any suitable social graph users.

The minimum number of edges needed to connect a player 101 (or player character) to another user is considered the degree of separation between them. For example, where the player 101 and the other user are directly connected (one edge), they are deemed to be separated by one degree of separation. The other user would be a so-called “first-degree friend” of the player 101. Where the player 101 and the other user are connected through one other user (two edges), they are deemed to be separated by two degrees of separation. This user would be a so-called “second-degree friend” of the player 101. Where the player 101 and the other user are connected through N edges (or N−1 other users), they are deemed to be separated by N degrees of separation. This other user would be a so-called “Nth-degree friend.” As used herein, the term “friend” means only first-degree friends, unless the context suggests otherwise.

Within the social graph, each player 101 (or player character) has a social network. A player 101's social network includes all users in the social graph within Nmax degrees of the player 101, where Nmax is the maximum degree of separation allowed by the system managing the social graph (such as, for example, the social networking system 120a or the game networking system 120b). In one embodiment, Nmax equals 1, so that the player 101's social network includes only first-degree friends. In another embodiment, Nmax is unlimited and the player 101's social network is coextensive with the social graph.

In particular embodiments, the social graph is managed by the game networking system 120b, which is managed by a game operator. In other embodiments, the social graph is part of a social networking system 120a managed by a third party (e.g., Facebook, Friendster, Myspace). In yet other embodiments, the player 101 has a social network on both the game networking system 120b and the social networking system 120a, wherein the player 101 can have a social network on the game networking system 120b that is a subset, superset, or independent of the player 101's social network on the social networking system 120a. In such combined systems, the game networking system 120b can maintain social graph information with edge type attributes that indicate whether a given friend is an “in-game friend,” an “out-of-game friend,” or both. The various embodiments disclosed herein are operable when the social graph is managed by the social networking system 120a, the game networking system 120b, or both.

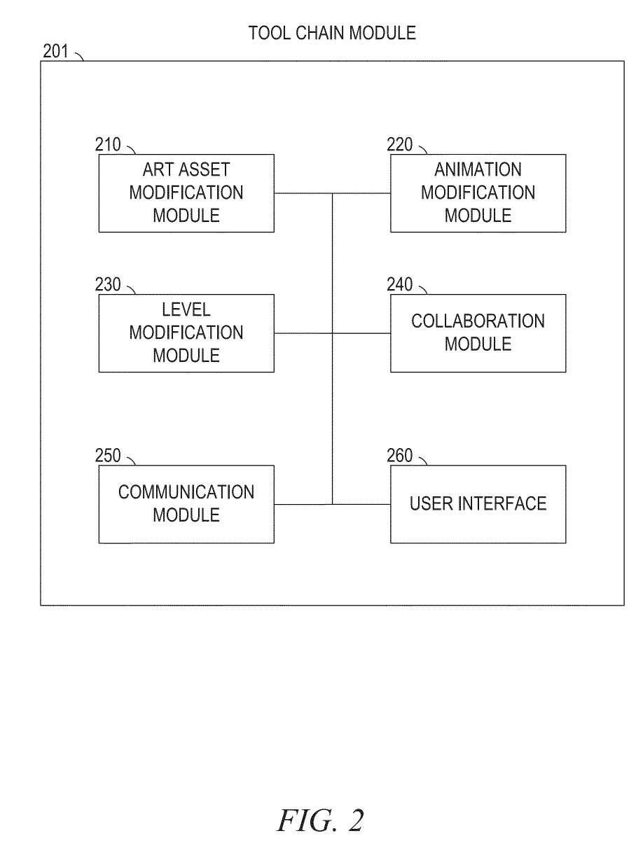

FIG. 2 is a block diagram illustrating components of a tool chain module 201, according to one example embodiment. In some instances, the game networking system 120b can include the tool chain module 201. The tool chain module 201 in this example embodiment includes an art asset modification module 210, an animation modification module 220, a level modification module 230, a collaboration module 240, a communication module 250, and a user interface 260.

The art asset modification module 210 can allow a game developer to seamlessly update (e.g., modify, generate) art assets in a game application. For example, in current implementations, a game developer (e.g., an artist) may use a native tool, such as a graphic editor, to create an art asset. Modification of an asset can include changes in the background image, the tile image, displayed game parameters, any visual asset in the game, and so on. Then, the asset from the graphic editor can be exported into an integrated development environment, such as Xcode. Additionally, the artist can further modify (e.g., color correction, batch resizing of photo) the asset using the integrated development environment. Then the output of the integrated development environment is converted to binary format in order to test the new asset in the game application. Furthermore, when the asset needs to be further modified based on the testing, then the artist starts again with the first step of modifying the asset in the native tool, such as the graphic editor.

In contrast, with the art asset modification module 210, the game developer simply makes the game modification associated with the art asset on the user interface 260. The game modification can be based on a change in an attribute associated with the art asset. The change in the attribute can be received from an input from the game developer on the user interface 260. The input can be based on features or edits normally associated with a graphic editor. Once the game modification is complete, the game developer can request to push (e.g., transmit) the game modification to the game application on the client system 130 seamlessly in real time via the network 160. The request can be as simple as selecting an export button on the user interface 260. As a result of the request, the game application on the client system 130 is updated in real time with the modified art asset without a user input from the player 101.

Similarly, the animation modification module 220 can allow a game developer to make a game modification associated with an animation on the user interface 260. For example, the game developer can generate a game modification associated with an animation on the user interface 260. The game modification can be based on a change in an attribute associated with the animation. The change in the attribute can be received from an input from the game developer on the user interface 260. The input can be based on features or edits normally associated with animation software. An animation modification can include changes such as how dialogues fly in, timing of animation, special effects (e.g., fading), and so on. Once the game modification is complete, the game developer can request to push (e.g., transmit) the game modification to the game application on the client system 130 seamlessly in real time via the network 160. As previously mentioned, the request can be as simple as selecting the export button on the user interface 260. As a result of the request, the game application on the client system 130 is updated in real time with the modified animation without a user input from the player 101.

With regard to current implementation, in an animation modification example, the animator can use a native animation tool to create or modify an animation. Then the output of the native animation tool is inputted into the integrated development environment, such as Xcode. The animators can further modify (e.g., change the timing of) the animation in the integrated development environment. Then the output of the integrated development environment is converted to binary format. Additionally, when the animation needs to be further modified based on the testing (e.g., the timing of the animation is incorrect), then the animator starts again with the first step of modifying the animation using the native animation tool. As described, current implementations of animation modification can be inefficient, in comparison to the methods described herein using the tool chain module 201.

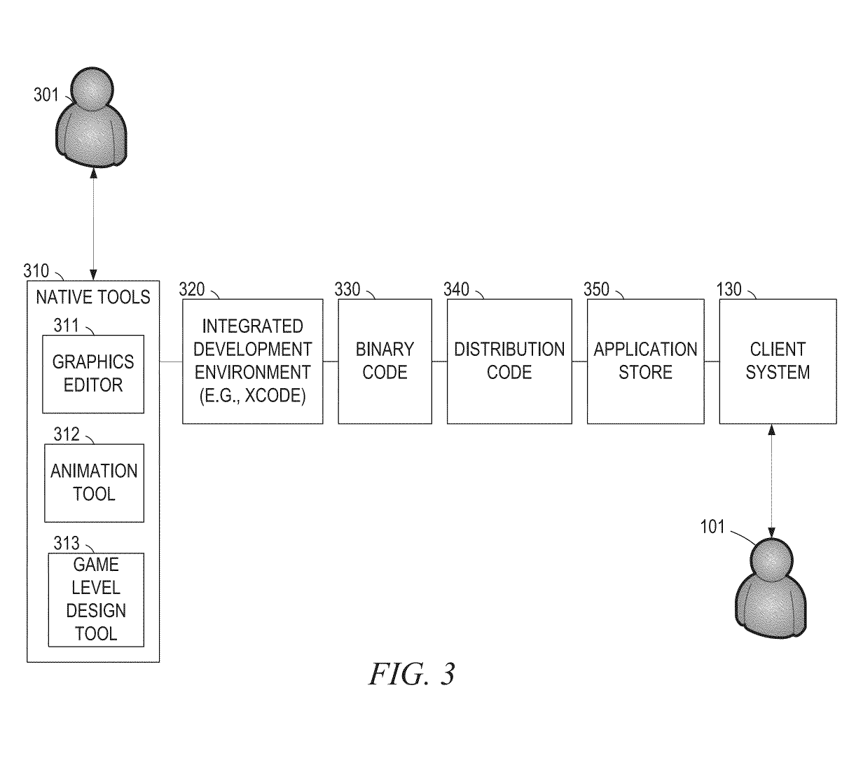

Additionally, the tool chain module 201 improves collaboration between game developers using the collaboration module 240. FIG. 3 illustrates a block diagram of components for designing a game level using current implementations. Designing a game level includes generating level-related information such as a design layout of the game.

To illustrate, in the first step, a game developer 301 (e.g., a first level designer) can create a level using native tools 310. The native tools can include a graphic editor 311, an animation tool 312, a game level design tool 313, and so on. In some instances, the game developer exports a first modification file (e.g., an asset created using the graphic editor 311) to the animation tool 213. The animation software is used to add animation to the asset before exporting a second modification file to an integrated development environment 320.

In the second step, the output from the native tools 310 can be exported into the integrated development environment 320. The integrated development environment 320 can contain a suite of software development tools for developing software for a specific operating system. Xcode is an example of the integrated development environment 320 that is developed by Apple® for developing software for Apple's mobile operating system (i.e., iOS). Using the integrated development environment 320, the modification to the game level can be built for the specific operating system.

In the third step, after the game level has been built, the output of the integrated development environment 320 is converted to binary code 330. The conversion to binary code 330 allows sharing with other level designers. The other level designers can download the binary code 330 to update the game application. The other level designers can then make modifications to a level using the updated game application.

Additionally, in the fourth step, the binary code 330 can be converted to distribution code 340, where the distribution code 340 is dependent on the operating system of the client device. Furthermore, in the fifth step, the distribution code 340 can be transmitted to an application store 350 to be downloaded, by a player 101, on a client system 130 in the sixth step.

In contrast, the collaboration module 240 allows collaboration without the arduous process listed above. For example, using the user interface 260 and the level modification module 230, a level designer can visually create a level using an extension of a software development kit (e.g., Unity). The level modification module 230 can access a software development kit which includes a rendering engine integrated with a set of tools and workflows to create interactive three-dimensional (3D) and two-dimensional (2D) content and publish on multiple platforms. Continuing with the example, once the level is created, the level designer can export (e.g., push, transmit) the created level to the game application. The export can be as simple as the level designer selecting the export button on the user interface 260 of the software development kit. Once the level is exported, other developers and players 101 can synchronize the game application, which includes the new level. The collaboration module 240 can synchronize the modifications between different developers.

Additionally, the tool chain module 201 allows the modification to be instantaneously reflected in the game application, and the modification is shared with other game developerers. Moreover, the newly generated game level can be included in the game application of game users (e.g., player 101) without the need to download the updated version of the game application from the application store. As previously mentioned, using the level modification module 230, a game developer can generate a new level for a game. Then the tool chain module 201 can modify the game application with the new level without having the user download an updated version of the game application from the application store.

In some instances, each level of a game can have a first modification information (e.g., level definition file), which can be modified by the tool chain module 201 and the level modification module 230. The level definition file can have attributes that can be modified by the tool chain module 201 using text representations associated with the attributes. The first modification information can include one or more attributes (e.g., game play parameters, game related data, game instances, player character state, features, or game level settings) that can be modified by the tool chain module 201 in order to customize a player 101's experience.

Furthermore, a first modification information (e.g., first level definition file) can be used by a level definition file module executing on a client computing device to modify a first set of attributes for a first level, and a second modification information (e.g., second level definition file) can be used by the level definition file module to modify a second set of attributes for a second level. Alternatively, the second modification information can be an art asset definition file or an animation file.

It is to be understood that, in some embodiments, the first modification information and the second modification information indicate different attributes that can be modified by the game developer using the tool chain module 201 using text representations associated with specific attributes (e.g., game play parameters, game related data, game instances, player character state, features, or game level settings). For example, a level definition file can indicate multiple attributes of a game level to be modified. The tool chain module 201 can update a level definition file to be processed by the client system 130. It is to be understood that such attributes as can be indicated for modification by a level definition file may include, but are not limited to, types of game obstacles or hazards, a rate of appearance of various types of game obstacles or hazards, types of game bonus opportunities, a rate of appearance of various types of game opportunities, a range of motion allowed for a player 101, a range of speed allowed for a player 101, a rate of appearance of one or more chances to earn bonuses, respective amounts of rewards, and a range of times to accomplish a game goal.

According to various embodiments, the tool chain module 201 can transmit content that can be processed by the game application installed on the client system 130 by formatting the information about the modification into text (e.g., American Standard Code for Information Interchange (ASCII) characters). By having a text representation of attributes associated with the game application, the tool chain module 201 can modify the game application by editing the text representation of the attributes. For example, a level may be associated with a text representation of attributes corresponding to specific details about the level, such as the layout, art assets used, starting title, drop rates of additional titles, and so on. The tool chain module 201 can specify all the attributes associated with the level in the text representation.

In some instances, the text representation can be packaged (e.g., encapsulated) by the tool chain module 201 with binary data and transmitted to the game networking system 120b or the client system 130. The packaged data can then be deciphered by the receiving system, which can be the game networking system 120b, the client system 130, or a software extension on the installed game application.

With regard to the software extension on the installed game application, the tool chain module 201 can include an extension for a software development kit (e.g., Unity), where the extension includes a proprietary data format that is consumable by the game application. As a result, the game application can easily be modified by the tool chain module 201, bypassing the multiple-step process previously described in current implementations.

By using the tool chain module 201, game developers can instantly share the modifications with other game developers (e.g., artists, animators, level designers), or players 101. Using the export function for the tool chain module 201, the modification can be pushed to the game application. Additionally, the game application can be updated with the modification without the player 101 having to download an updated version of the game application from the application store.

Continuing with the collaboration example, the modifications from a plurality of developers can be transmitted to the game networking system 120b, and the client system 130 can retrieve the modifications from the game networking system 120b. The modifications can automatically be retrieved during a synchronization of the game application. The collaboration module 240 helps resolve potential conflicts between similar attributes associated with the game modification.

For example, initially, the game application is downloaded on the client system 130. Then, during subsequent synchronization, the modifications are automatically retrieved. Synchronization can occur when a game is started, when a level is completed, when a player 101 returns to a game after a paused session, and so on. During the synchronization, the version of the game application installed on the client system 130 is compared against the most current version of the game application on the game networking system 120b. In response to the comparison, if the game application installed on the client system 130 is not the most current version of the game application, then the modifications associated with the most current version are retrieved by the client system 130 from the game networking system 120b. For example, the game application can determine the differences between the versions, and automatically incorporate the new updates.

Because modifications from the game networking system 120b are automatically retrieved, the game developers do not need to submit a request to application store in order to update the game application. Because the game developers do not need to submit a request to the application store, the process of updating the game application is significantly reduced.

According to various embodiments, the text representations corresponding to a modification can be processed by the client system 130, which in turn updates the game application stored on the client system 130. Alternatively, the game networking system 120b can process the text representations corresponding to the modification, and transmit processed data to the client system 130.

In the instances where the client system 130 processes the text representations corresponding to a modification, the client system 130 can determine the modification based on the retrieved text representation. The client system 130 can have a software extension, custom code, or hardware to handle the output (e.g., text representation) from the tool chain module 201. The custom code or hardware can be implemented by the client system 130 or the game application. The output from the extension of the software development kit is an example of an output from the tool chain module 201.

For example, a game developer can create a new level using the tool chain module 201 and transmit the new level to the game networking system 120b. On the client side, during synchronization, the game application determines that a newer version exists, and therefore automatically updates the game by incorporating the new level. The modifications associated with the game are translated into text representations, which are transmitted to the client system 130 via a retrieval request by the game application.

The synchronization can be controlled by the collaboration module 240 to check for deltas (e.g., differences) between different versions of the game application. In some instances, the collaboration module 240 can be part of the game application installed in the client system 130. By keeping track of the versions and the deltas between the versions, the game application can request specific modifications via a package from the game networking system 120b. Alternatively, the game networking system 120b can push specific modifications via a package to the client system 130 based on a received version number of the game application installed on the client system 130. The package can include all the modifications that are now incorporated in the newest version of the game in comparison to the version of the game installed on the client system 130.

The collaboration module 240 can include a state machine. The state machine can keep track of all the modifications that have been incorporated in each incremental update. In some instances, the same art asset can be updated several times between synchronizations, but only the most recent version of the art asset is pushed to the client system 130. As a result of the collaboration module 240, the updates are less time-consuming, the data size associated with the package update is smaller, which reduces the network burden, and the processing time is reduced.

For example, with the collaboration module 240, a plurality of game developers can independently change the same art asset. The tool chain module 201 can determine the most up-to-date art asset without requiring the plurality of game developers to communicate with each other. The tool chain module 201 can automatically synchronize the game application, so the game developers will have the most up-to-date information without having to manually download a newer version of the game application.

Additionally, the collaboration module 240 includes a conflict resolution feature so that a plurality of modifications can be implemented together. For example, a first game developer can change an art asset (e.g., changing a letter from F to E), and a second game developer can change the background. In this instance, the collaboration module 240 can implement both modifications during synchronization since the modifications do not conflict with each other.

Continuing with the conflict resolution feature for the multiple designer example, the collaboration module 240 can determine and resolve all the modifications for the game application based on attributes. For example, an attribute for a word game can include, but is not limited to, the number of moves, the starting pattern of tiles, the layout of letters, the objective types, the order of the levels, what tiles drop in, a bonus meter, metering parameters, and so on. When the attributes of two modifications are different, both modifications can be implemented by the tool chain module 201. Alternatively, when the attributes are the same, then the most recent modification is implemented.

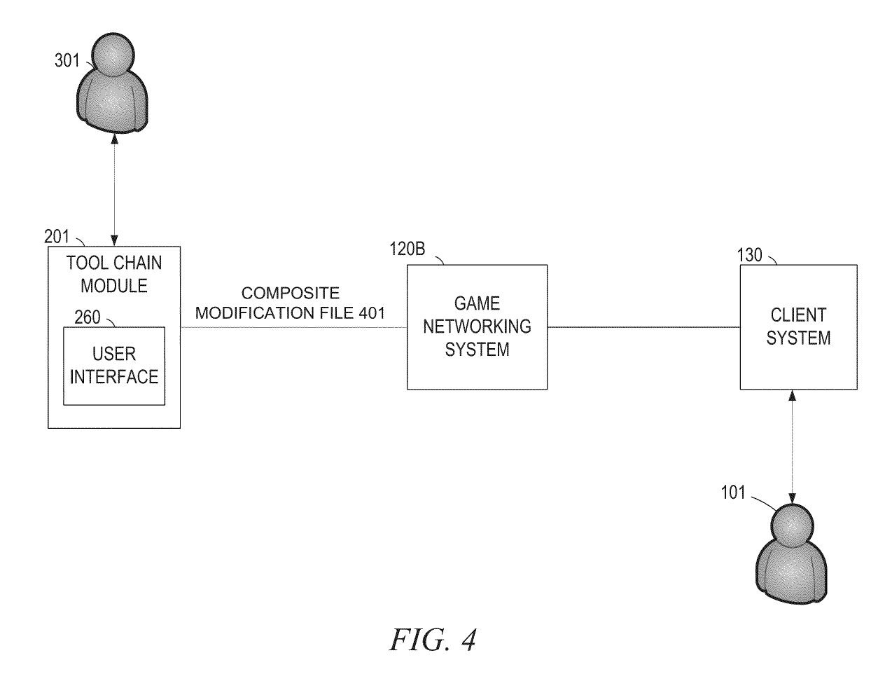

In various example embodiments, the communication module 250 is a hardware-implemented module that controls, manages, and stores information related to sending a composite modification file to a client system 130, game networking system 120b, or social networking system 120a. The user interface 260 is a module that can receive user input (e.g., input from a game developer 301) for the tool chain module 201. The user interface is further described in the discussion of FIG. 4.

The modules 210-260 are configured to communicate with each other (e.g., via a bus, shared memory, or a switch). Any one or more of the modules 210-260 described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 4 illustrates a block diagram of components for designing a game level using the tool chain module 201, according to various embodiments. For example, a game developer 301 can create an asset using the user interface 260 of the tool chain module 201. Then, once the asset is created, using the same user interface 260 of the tool chain module 201, the game developer 301 can add animation to the created asset. Subsequently, the animation and the asset are combined and pushed to the game application. The tool chain module 201 presents the game developer 301 a user interface 260 that allows for the visualization of a plurality of different development tools in a single user interface 260. The single user interface 260 allows the game developer 301 the ability to adjust the modification in real time without having to go back and forth between different development tools. The tool chain module 201 can merge the output of the plurality of the development tools, and present the merged output in a single interface.

After the game modification is generated, the output of the tool chain module 201 can be pushed (e.g., uploaded) onto the game networking system 120b. The output of the tool chain module 201 can be a composite modification file 401. The composite modification file 401 can include text representations of attributes (e.g., game play parameters, game related data, game instances, player character state, features, or game level settings) associated with the game modification. Additionally, the output of the tool chain module 201 can be automatically encapsulated with binary code or distribution code in order for the game application on the client system 130 to automatically receive the information. The game modification (e.g., composite modification file 401) can be received without a request from a player 101.

Furthermore, the composite modification file 401 can be transmitted to the client system 130. In some instances, a client system 130 may already have the game application installed. The game application can include software to decapsulate the information received from the tool chain module 201. Decapsulation can include removing the binary code or distribution code to obtain the text representations of attributes associated with the game modification. Once the information received is decapsulated, the client system 130 can read the composite modification file 401 and process the modifications to update the game application. Additionally, the game networking system 120b can push the modification to the client system 130 and update the game without requiring the client system 130 to re-install a new version of the game.

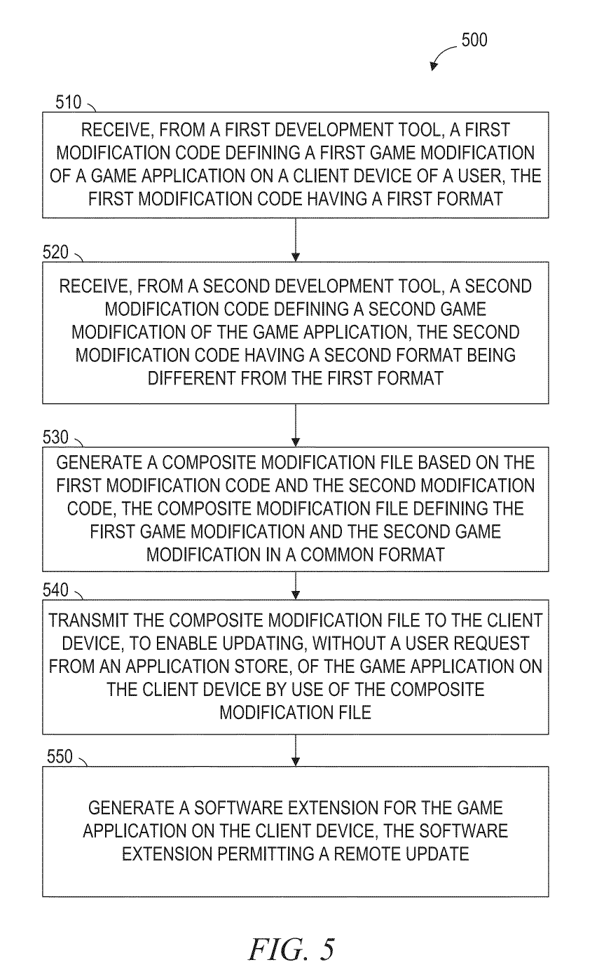

FIG. 5 is a flowchart showing an example method 500 of seamlessly updating a game application, according to some embodiments.

At operation 510, the tool chain module 201 can receive, from a first development tool, a first modification code. The first modification code (e.g., first file) can define a first game modification of a game application on a client device (e.g., client system 130) of a user (e.g., player 101). In some instances, the tool chain module 201 can receive modification information from the first development tool. Additionally, the first modification code can have a first format. The first modification code can have attributes corresponding to the game modification. The first modification code can be received using the communication module 250. The first development tool can include a graphic editor, animation software, game level generation software, or another tool used to modify a game application. Depending on the first development tool, the art asset modification module 210, the animation modification module 220, the level modification module 230, and the collaboration module 240 can take the attributes of the first modification code and automatically convert the attributes into a standard format (e.g., text representation) to be included in the composite modification file 401.

In some instances, the features (e.g., methods of modifying the art asset, methods of modifying the animation, methods of modifying the game level) of the first development tool can be presented on the user interface 260, and the received input from a game developer can relate to an attribute associated with a feature of the first development tool. For example, the game developer can change the letter “E” to an “F” in a word puzzle (e.g., Words on Tour®) game application. In this example, the first development tool is a graphic editor. The graphic editor can have features such as changing a letter, changing a color, and so on. Continuing with this example, the attribute in the first modification code can be the specific letter for a specific tile in the word puzzle. The game developer can change the letter for the specific tile by selecting, on the user interface 260, a feature associated with changing letters for a tile.

At operation 520, the tool chain module 201 can receive, from a second development tool, a second modification code. The second modification code (e.g., second file) can define a second game modification of the game application. The second modification code can have a second format being different from the first format. The second modification code can be received using the communication module 250 or the user interface 260. Depending on the second development tool, the art asset modification module 210, the animation modification module 220, the level modification module 230, and the collaboration module 240 can take the attributes of the second modification code and automatically convert the attributes into a standard format (e.g., text representation) to be included in the composite modification file 401.

The second modification code can have attributes corresponding to the same game modification as in operation 510, or a different game modification. For example, the first modification code can correspond to an output of a graphic editor tool, while the second modification code can correspond to an output of the animation software. Continuing with the example, in addition to changing the letter on the tile at operation 510, the game developer can use the animation software to add animation to the same tile. Alternatively, in another example, a game developer can use the animation software to modify a current animation (e.g., fading of background) in the word puzzle. In these examples, the animation modification module 220 can receive the second modification code and convert the attributes into a standard format to be included in the composite modification file 401.

At operation 530, the tool chain module 201 can generate a composite modification file 401 based on the first modification code and the second modification code. The composite modification file 401 can define the first game modification and the second game modification in a common format. The composite modification file 401 can include attributes from the first modification code and the second modification code. Using the art asset modification module 210, the animation modification module 220, and the level modification module 230, the attributes of the first modification code and the second modification code can be converted into a text representation to be included in the composite modification file 401. Additionally, the collaboration module 240 can resolve conflicts between the first modification code and the second modification code. As previously mentioned, the collaboration module 240 can have a state machine for each attribute, and only include the most current version of the attribute based on the state machine.

At operation 540, the tool chain module 201 can transmit the composite modification file 401 to the client device (e.g., client system 130). The tool chain module 201 can use the composite modification file 401 to update the game application on the client system 130. Updating of the game application on the client system 130 can be enabled by use of the composite modification file 401. The updating can be enabled without a user request from an application store 350. In some instances, the game application can be updated without a user request to download a newer version of the game application from the application store 350. For example, the composite modification file 401 can be pushed to the game application on the client system 130 directly from the game networking system 120b. The composite modification file 401 can be uploaded into the game networking system 120b by a game developer.

At operation 550, the tool chain module 201 can generate a software extension for the game application. The software extension can be installed on the client device. In some instances, the software extension is installed when the player 101 requests a newer version of the game application from the application store 350. Using the software extension, the tool chain module 201 or the game networking system 120b can remotely update the game application installed on the client device without having the player 101 manually request an update.

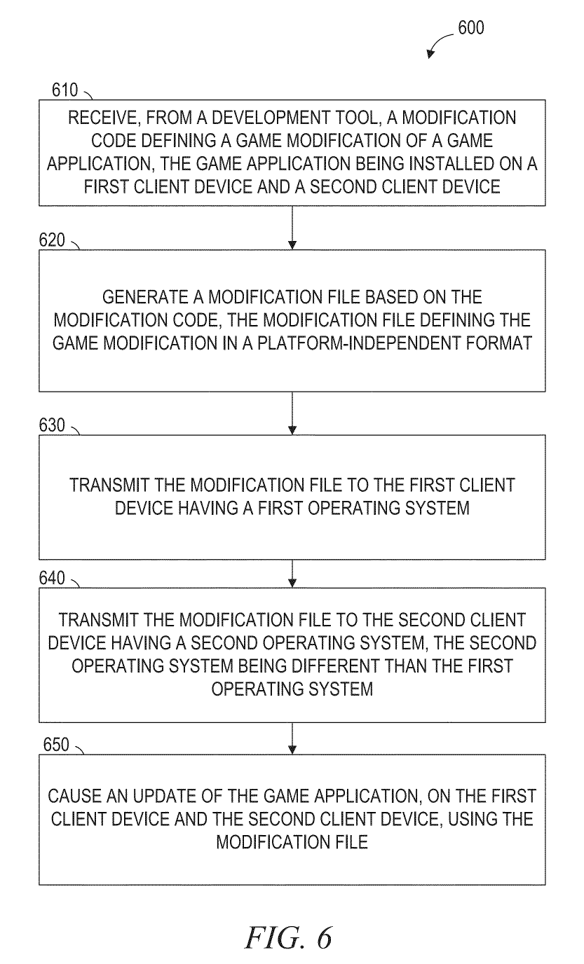

FIG. 6 is a flowchart showing an example method 600 of generating and transmitting a modification file to two different client devices for updating a game application, according to some embodiments.

In some instances, the modification file is transmitted to the two different client devices (e.g., a first client device and a second client device) for testing purposes by the game developers to ensure that a game modification is displayed correctly on the different client devices. For example, the client devices can include any potential computing platform (e.g., personal computers, virtual reality device, augmented reality device, and Internet of Things). The Internet of Things can include a network of physical objects embedded with electronics, software, sensors, and connectivity to enable objects to exchange data with the production, operator or other connected devices.

At operation 610, the tool chain module 201 can receive, from a development tool, a modification code defining a game modification of a game application. The game application can be installed on a first client device and a second client device. The modification code (e.g., first file) can define a first game modification of a game application on a client device (e.g., client system 130) of a user (e.g., player 101). In some instances, the tool chain module 201 can receive modification code from a first development tool. Additionally, the modification code can have a first format. The modification code can have attributes corresponding to the game modification. The modification code can be received using the communication module 250. The development tool can include a graphic editor, animation software, game level generation software, or another tool used to modify a game application. Depending on the development tool, the art asset modification module 210, the animation modification module 220, the level modification module 230, and the collaboration module 240 can take the attributes of the modification code and automatically convert the attributes into a standard format (e.g., text representation) to be included in the composite modification file 401.

At operation 620, the tool chain module 201 can, in an automated operation using one or more computer processors configured to perform the automated operation, generate a modification file (e.g., composite modification file 401) based on the modification code. The modification file can define the game modification in a platform-independent format. A platform-independent format can allow the modification file to be installed in two different platforms. The different platform can include different operating systems (e.g., Apple iOS™, Android OS™), different hardware systems (e.g., mobile device, tablet), and so on.

In some instances, the modification file includes text representations of the attributes associated with the game modification.

In some instances, the modification file is not converted to binary code when generated at operation 620.

In some instances, the modification file does not include a distribution code when generated at operation 620.

In some instances, the modification file is a single text file.

In some instances, the method 600 can further include the tool chain module 201 receiving, from a second development tool, a second modification code defining another game modification of the game application. The second modification code can have a different file format than the modification code. For example, the first development tool of operation 610 can be a graphic editor (e.g., art asset modification module 210), and the second development tool can be animation software (e.g., animation modification module 220). Additionally, the composite modification file 401 generated at operation 620 can be further generated based on the second modification code. The second modification code can be received using the communication module 250 or the user interface 260.

Depending on the first development tool, the art asset modification module 210, the animation modification module 220, the level modification module 230, and the collaboration module 240 can take the attributes of the first modification code and automatically convert the attributes into a standard format (e.g., text representation) to be included in the composite modification file 401. The second modification code can have attributes corresponding to the same game modification as in operation 610, or a different game modification. For example, the first modification code can correspond to an output of the graphic editor, while the second modification code can correspond to an output of the animation software.

Additionally, the composite modification file 401 can define the first game modification of operation 610 and a second game modification in a common format. The composite modification file 401 can include attributes from the first modification code and the second modification code. Using the art asset modification module 210, the animation modification module 220, and the level modification module 230, the attributes of the first modification code and second modification code can be converted into a text representation to be included in the composite modification file 401. Additionally, the collaboration module 240 can resolve conflicts between the first modification code and the second modification code. As previously mentioned, the collaboration module 240 can have a state machine for each attribute, and only include the most current version of the attribute based on the state machine.

At operation 630, the tool chain module 201 can transmit the modification file (e.g., composite modification file 401) to the first client device (e.g., client system 130) having a first operating system. For example, the first operating system can be the Apple iOS operating system. The tool chain module 201 can use the composite modification file 401 to update the game application on the first client system 130. Updating of the game application on the first client device can be enabled by use of the composite modification file 401. The updating can be enabled without a user request from an application store 350. In some instances, the game application can be updated without a user request to download a newer version of the game application from the application store 350. For example, the composite modification file 401 can be pushed to the game application on the client device directly from the game networking system 120b. The composite modification file 401 can be uploaded into the game networking system 120b by a game developer.

At operation 640, the tool chain module 201 can transmit the modification file (e.g., composite modification file 401) to the second client device having a second operating system, the second operating system being different from the first operating system. For example, the second operating system can be the Android operating system, where the first operating system is the Apple iOS operating system. The tool chain module 201 can use the composite modification file 401 to update the game application on the second client device. For example, the game modification (e.g., composite modification file 401) can be pushed to the game application on the second client device directly from the game networking system 120b.

As previously mentioned, the first client device and the second client device can be used for testing purposes by the game developers to ensure that the game modification is displayed correctly on the first client device and the second client device. By viewing the game modification on different client devices, the game developers can ensure that the art asset, animation, or game level are properly generated.

In some instances, the first client device can have a first user interface and the second client device can have a second user interface. The first user interface can be different from the second user interface. For example, the first user interface can have a different display resolution than the second user interface. The first user interface can be associated with a mobile phone, which may have a smaller display resolution than the second user interface of a tablet.

Additionally, the first user interface can have a different screen size than the second user interface. Moreover, the first user interface can have a different aspect ratio than the second user interface. Furthermore, the first client device can have a different processing speed than the second client device. The first client device can have a different random access memory (RAM) capability than the second client device.

In some instances, the first client device can be a mobile phone and the second client device can be a tablet, a desktop computer, virtual glasses, or augmented-reality googles. For example, the first operating system can be a mobile operating system (e.g., Apple iOS), and the second operating system can be a desktop-oriented operating system (e.g., Microsoft Windows).

In some instances, the development tool from operation 610 can be a graphic editor, and the second development tool can be an animation software or game level generation software.

At operation 650, the tool chain module 201 can cause an update of the game application, on the first client device and the second client device, using the modification file. As previously described, the game application can be updated on both the first client device and the second client device using the same modification file (e.g., composite modification file 401). Given that the modification file is generated in a platform-independent format at operation 620, the same modification file can be installed on a plurality of devices, regardless of the operating system or user interface (e.g., user interface layout) on the device.

Additionally, in some instances, a software extension can be installed on the first client device and the second client device. Using the software extension, the tool chain module 201 or the game networking system 120b can remotely update the game application installed on the first client device and the second client device without having the player 101 manually request an update.

In some instances, the method 600 can further include transmitting the modification file to a third client device, and causing an update of the game application on the third client device using the modification file, the third client device having a different platform (e.g., operating system, user interface) than the first client device and the second client device.

In some instances, the modification file is configured for execution by the client device to modify an existing code of the game application by incorporating the attributes into the existing code. For example, the attributes may include art asset parameters, animation parameters, game play parameters, player character state, or game level settings.

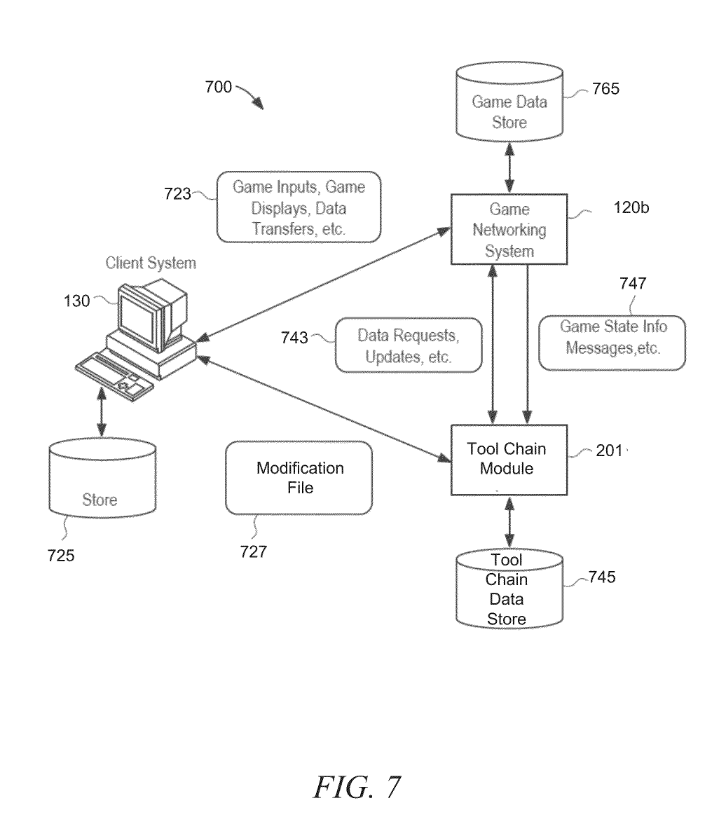

FIG. 7 illustrates an example data flow between the components of a system 700. In particular embodiments, the system 700 can include the client system 130, the tool chain module 201, and the game networking system 120b (i.e., online game system). The components of the system 700 can be connected to each other in any suitable configuration, using any suitable type of connection. The components may be connected directly or over any suitable network. The client system 130, tool chain module 201, and game networking system 120b can each have one or more corresponding data stores, such as a local data store 725, a tool chain data store 745, and a game data store 765, respectively. The tool chain module 201 and the game networking system 120b can also have one or more servers that can communicate with the client system 130 over an appropriate network 160. The tool chain module 201 and the game networking system 120b can have, for example, one or more Internet servers for communicating with the client system 130 via the Internet. Similarly, the tool chain module 201 and the game networking system 120b can have one or more mobile servers for communicating with the client system 130 via a mobile network (e.g., GSM, PCS, Wi-Fi, WPAN, etc.). In some embodiments, one server may be able to communicate with the client system 130 over both the Internet and a mobile network. In other embodiments, separate servers can be used.

The client system 130 can receive and transmit data 723 to and from the game networking system 120b. This data 723 can include, for example, webpages, messages, game inputs, game displays, HTTP packets, data requests, transaction information, updates, and other suitable data. At some other time, or at the same time, the game networking system 120b can communicate data 743, 747 (e.g., game state information, game system account information, page info, messages, data requests, updates, etc.) with other networking systems, such as the tool chain module 201. The client system 130 can also receive and transmit a modification file 727 (e.g., the composite modification file 401 from operation 530) to and from the tool chain module 201. This modification file 727 can include, for example, attributes associated with a game modification for the game application.

Communication among the client system 130, the tool chain module 201, and the game networking system 120b can occur over any appropriate electronic communication medium or network 160 using any suitable communications protocols. For example, the client system 130, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end systems described herein may use a variety of higher layer communications protocols, including client-server (or request-response) protocols, such as the Hypertext Transfer Protocol (HTTP) and other communications protocols, such as HTTPS, FTP, SNMP, TELNET, and a number of other protocols. In some embodiments, no protocol may be used and, instead, transfer of raw data may take place via TCP or User Datagram Protocol. In addition, a server in one interaction context may be a client in another interaction context. In particular embodiments, the information transmitted between hosts may be formatted as Hypertext Markup Language (HTML) documents. Other structured document languages or formats can be used, such as XML and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, the modification file 727 can include a set of game state parameters that characterize the state of various in-game objects, such as, for example, a game state, player character state parameters, non-player character parameters, and virtual item parameters. In particular embodiments, the game state is maintained in a database as a serialized, unstructured string of text data as a so-called binary large object (BLOB). When a player 101 accesses an online game on the game networking system 120b, the BLOB containing the game state for the instance corresponding to the player 101 can be transmitted to the client system 130 for use by a client-side executable. In particular embodiments, the client-side executable may be a Flash-based game, which can de-serialize the game state data in the BLOB. As the player 101 plays the game, the game logic implemented at the client system 130 maintains and modifies the various game state parameters locally. The client-side game logic may also batch game events, such as mouse clicks, and transmit these events to the game networking system 120b. The game networking system 120b may itself operate by retrieving a copy of the BLOB from a database or an intermediate memory cache (memcache) layer. The game networking system 120b can also de-serialize the BLOB to resolve the game state parameters and execute its own game logic based on the events in the batch file of events transmitted by the client to synchronize the game state on the server side. The game networking system 120b may then re-serialize the game state, now modified, into a BLOB and pass this to a memory cache layer for lazy updates to a persistent database.

With a client-server environment in which the online game may run, one server system, such as the game networking system 120b, may support multiple client systems 130. At any given time, there may be multiple players 101 at multiple client systems 130 all playing the same online game. In practice, the number of players 101 playing the same game at the same time may be very large. As the game progresses with each player 101, multiple players 101 may provide different inputs to the online game at their respective client systems 130, and multiple client systems 130 may transmit multiple player inputs and/or game events to the game networking system 120b for further processing. In addition, the multiple client systems 130 may transmit other types of application event data to the game networking system 120b.

Application event data of a game is any data relevant to the game (e.g., player inputs). In particular embodiments, each application event datum may have a name and a value, and the value of the application event datum may change (i.e., be updated) at any time. When an update to an application event datum occurs at the client system 130, caused either by an action of a player 101 or by the game logic itself, the client system 130 may need to inform the game networking system 120b of the update. For example, if the game is a farming game with a harvest mechanic (such as Zynga FarmVille), an event can correspond to a player 101 clicking on a parcel of land to harvest a crop. In such an instance, the application event data may identify an event or action (e.g., harvest) and an object in the game to which the event or action applies. For illustration purposes and not by way of limitation, the system 700 is discussed with reference to updating a multi-player online game hosted on a network-addressable system (such as, for example, the tool chain module 201 or the game networking system 120b), where an instance of the online game is executed remotely on the client system 130, which then transmits application event data to the hosting system such that the remote game networking system 120b synchronizes a game state associated with the instance executed by the client system 130.

In a particular embodiment, one or more objects of a game may be represented as an Adobe Flash object. To ensure synchronization between the Flash object shown to the player 101 at the client system 130 and the game state stored at the game networking system 120b, the Flash client may send events that cause game state changes to the in-game object to the game networking system 120b. However, to expedite the processing and hence the speed of the overall gaming experience, the collaboration module 240 may collect a batch of some number of events or updates into a batch file. The number of events or updates may be determined by the Flash client dynamically or determined by the game networking system 120b based on server loads or other factors. For example, the client system 130 may send a batch file to the game networking system 120b whenever 50 updates have been collected or after a threshold period of time, such as every minute.

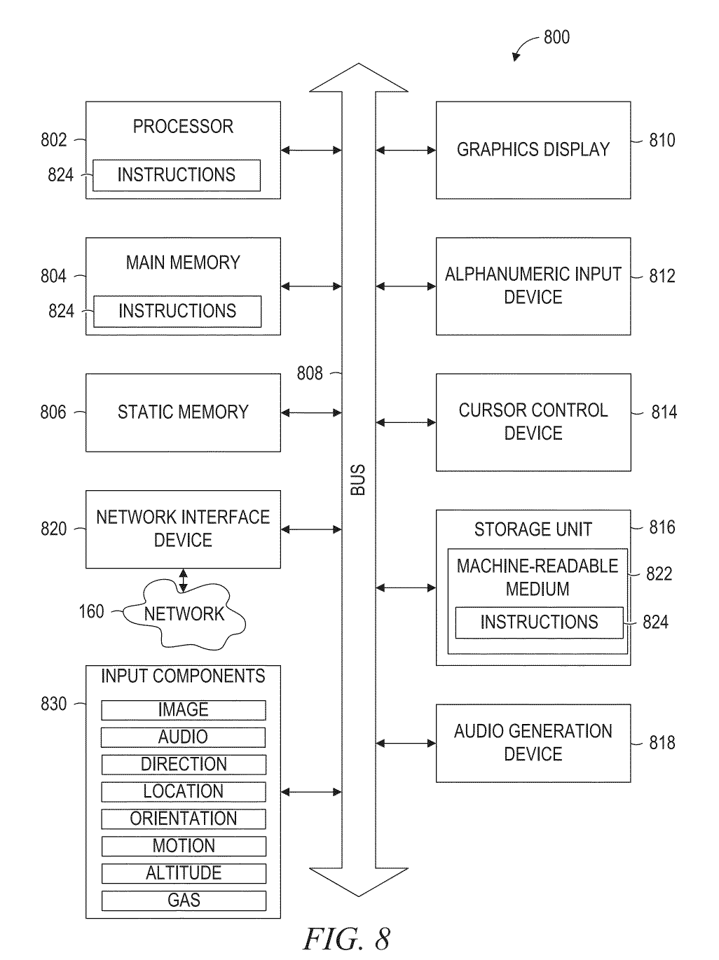

FIG. 8 is a block diagram illustrating components of a machine 800 (e.g., client system 130, social networking system 120a, game networking system 120b, tool chain module 201), according to some example embodiments. The machine 800 is able to read instructions 824 from a machine-readable medium 822 (e.g., a non-transitory machine-readable medium, a machine-readable storage medium, a computer-readable storage medium, or any suitable combination thereof) and perform any one or more of the methodologies discussed herein, in whole or in part. Specifically, FIG. 8 shows the machine 800 in the example form of a computer system (e.g., a computer) within which the instructions 824 (e.g., software, a program, an application, an applet, an app, or other executable code) for causing the machine 800 to perform any one or more of the methodologies discussed herein may be executed, in whole or in part.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 824, sequentially or otherwise, that specify actions to be taken by that machine. Further, while only a single machine 800 is illustrated, the term “machine” shall also be taken to include any collection of machines 800 that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824, such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a graphics display 810 (e.g., a plasma display panel (PDP), a light emitting diode (LED) display, a liquid crystal display (LCD), a projector, a cathode ray tube (CRT), or any other display capable of displaying graphics or video). The machine 800 may also include an alphanumeric input device 812 (e.g., a keyboard or keypad), a cursor control device 814 (e.g., a mouse, a touchpad, a trackball, a joystick, a motion sensor, an eye tracking device, or another pointing instrument), a storage unit 816, an audio generation device 818 (e.g., a sound card, an amplifier, a speaker, a headphone jack, or any suitable combination thereof), and a network interface device 820.

The storage unit 816 includes the machine-readable medium 822 (e.g., a tangible and non-transitory machine-readable storage medium) on which are stored the instructions 824 embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered machine-readable media 822 (e.g., tangible and non-transitory machine-readable media). The instructions 824 may be transmitted or received over the network 160 via the network interface device 820. For example, the network interface device 820 may communicate the instructions 824 using any one or more transfer protocols (e.g., Hypertext Transfer Protocol (HTTP)).

In some example embodiments, the machine 800 may be a portable computing device, such as a smartphone or tablet computer, and may have one or more additional input components 830 (e.g., sensors or gauges). Examples of such input components 830 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 830 may be accessible and available for use by any of the modules described herein.

As used herein, the term “memory” refers to a machine-readable medium 822 able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store the instructions 824. The term “machine-readable medium” shall also be taken to include any medium, or combination of multiple media, that is capable of storing the instructions 824 for execution by the machine 800, such that the instructions 824, when executed by one or more processors of the machine 800 (e.g., processor 802), cause the machine 800 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 822 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 802) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor 802. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 802 configured by software to become a special-purpose processor, the general-purpose processor 802 may be configured as respectively different special-purpose processors (e.g., comprising different hardware modules) at different times. Software (e.g., a software module) may accordingly configure one or more processors 802, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 808) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 802 that are temporarily configured (e.g., by software) or permanently configured to perform the relevant operations. Whether temporarily or permanently configured, such processors 802 may constitute processor-implemented modules that operate to perform one or more operations or functions described herein. As used herein, “processor-implemented module” refers to a hardware module implemented using one or more processors 802.

Similarly, the methods described herein may be at least partially processor-implemented, a processor 802 being an example of hardware. For example, at least some of the operations of a method may be performed by one or more processors 802 or processor-implemented modules. As used herein, “processor-implemented module” refers to a hardware module in which the hardware includes one or more processors 802. Moreover, the one or more processors 802 may also operate to support performance of the relevant operations in a “cloud computing” environment or as a “software as a service” (SaaS). For example, at least some of the operations may be performed by a group of computers (as examples of machines 800 including processors 802), with these operations being accessible via a network 160 (e.g., the Internet) and via one or more appropriate interfaces (e.g., an application programming interface (API)).

The performance of certain operations may be distributed among the one or more processors 802, not only residing within a single machine 800, but deployed across a number of machines 800. In some example embodiments, the one or more processors 802 or processor-implemented modules may be located in a single geographic location (e.g., within a home environment, an office environment, or a server farm). In other example embodiments, the one or more processors 802 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 800. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 800 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A computer-implemented method, comprising:
receiving, from a development tool, a modification code defining a game modification of a game application, the game application being installed on a first client device and a second client device;
in an automated operation using one or more computer processors configured to perform the automated operation, generating a modification file based on the modification code, the modification file defining the game modification in a platform-independent format; and
transmitting the modification file to the first client device having a first operating system;
transmitting the modification file to the second client device having a second operating system, the second operating system being different from the first operating system; and
causing an update of the game application, on the first client device and the second client device, using the modification file.

2. The method of claim 1, wherein the first client device has a first user interface and the second client device has a second user interface, the first user interface being different from the second user interface.

3. The method of claim 2, wherein the first user interface has a different display resolution than the second user interface.

4. The method of claim 2, wherein the first user interface has a different screen size than the second user interface.

5. The method of claim 2, wherein the first user interface has a different aspect ratio than the second user interface.

6. The method of claim 1, wherein the first client device has a different processing speed than the second client device.

7. The method of claim 1, wherein the first client device has a different random access memory (RAM) capability than the second client device.

8. The method of claim 1, wherein the first client device is a mobile phone and the second client device is a tablet.

9. The method of claim 1, wherein the first operating system is a mobile operating system, and the second operating system is a desktop-oriented operating system.

10. The method of claim 1, further comprising:
receiving, from a second development tool, a second modification code defining another game modification of the game application, the second modification code having a different file format than the modification code; and
wherein the modification file is further generated based on the second modification code.

11. The method of claim 10, wherein the development tool is a graphic editor, and the second development tool is animation software.

12. The method of claim 1, wherein the modification file includes text representations of attributes associated with the game modification.

13. The method of claim 12, wherein the modification file is configured for execution by the first client device and the second client device to modify an existing code of the game application by incorporating the attributes into the existing code.

14. The method of claim 12, wherein the attributes include art asset parameters, animation parameters, game play parameters, a player character state, or game level settings.

15. The method of claim 1, wherein the modification file is not converted to binary code.

16. The method of claim 1, wherein the modification file does not include distribution code.

17. The method of claim 1, wherein the modification file is a single text file.

18. A system comprising:
a transceiver configured to:
receive, from a development tool, a modification code defining a game modification of a game application, the game application being installed on a first client device and a second client device; and
one or more computer processors configured by a tool chain module to:
generate a modification file based on the modification code, the modification file defining the game modification in a platform-independent format;
transmit the modification file to the first client device having a first operating system;
transmit the modification file to the second client device having a second operating system, the second operating system being different from the first operating system; and
cause an update of the game application, on the first client device and the second client device, using the modification file.

19. The system of claim 18, wherein the first client device has a first user interface and the second client device has a second user interface, the first user interface being different from the second user interface.

20. A non-transitory machine-readable storage medium comprising instructions that, when executed by one or more processors of a machine, cause the machine to perform operations comprising:
receiving, from a first development tool, a first modification code defining a first game modification of a game application on a client device of a user, the first modification code having a first format;
receiving, from a second development tool, a second modification code defining a second game modification of the game application, the second modification code having a second format being different from the first format;
generating a composite modification file based on the first modification code and the second modification code, the composite modification file defining the first game modification and the second game modification in a common format; and
transmitting the composite modification file to the client device, to enable updating, without a user request from an application store, of the game application on the client device by use of the composite modification file.
